(19) United States
(12) Patent Application Publication
(10) Pub. No.: US 2025/0256356 A1
(43) Pub. Date: Aug. 14, 2025

(54) METHOD, CONTROL PROGRAM, AND PLANNING DEVICE FOR A POWDER BED-BASED ADDITIVE MANUFACTURE IN LAYERS

(71) Applicant: TRUMPF Laser- und Systemtechnik SE, Ditzingen (DE)

(72) Inventor: Bernhard Gutmann, Pfaffenhofen a.d. Glonn (DE)

(21) Appl. No.: 19/181,367

(22) Filed: Apr. 17, 2025

Related U.S. Application Data
(63) Continuation of application No. PCT/EP2023/077838, filed on Oct. 9, 2023.

(30) Foreign Application Priority Data
Oct. 18, 2022 (DE) 10 2022 127 241.9

(51) Int. Cl. B23K 26/342; B22F 10/28; B22F 12/45; B22F 12/70; B23K 26/06; B23K 26/08; B23K 26/14; B33Y 10/00; B33Y 50/02

(52) U.S. Cl. CPC B23K 26/342; B22F 10/28; B22F 12/45; B22F 12/70; B23K 26/0604; B23K 26/14; B33Y 10/00; B33Y 50/02; B23K 26/08

(57) ABSTRACT

A method for an additive manufacture of at least one component in layers in a powder bed uses at least two beams which can be deflected two-dimensionally. The method includes: dividing the powder bed including multiple powder bed layers into multiple segments by means of multiple segmentation lines running approximately perpendicularly to a direction of a gas flow, wherein the gas flows in a substantially parallel manner over the powder bed; solidifying, using the at least two beams, the at least one component to be solidified by means of a substantially equal laser load within a segment of a powder bed layer of the multiple powder bed layers; and adapting individual segmentation lines of each powder bed layer based on a criterion.

### CROSS REFERENCE TO RELATED APPLICATIONS

This application is a continuation of International Application No. PCT/EP2023/077838 (WO 2024/083543 A1), filed on Oct. 9, 2023, and claims benefit to German Patent Application No. DE 10 2022 127 241.9, filed on Oct. 18, 2022. The aforementioned applications are hereby incorporated by reference herein.

### FIELD

The present invention relates to a method for an additive manufacture of at least one component in layers in a powder bed, a control program configured to carry out all the steps of the method, and a planning device for creating a control program for controlling a machine for an additive manufacture of at least one component in layers in a powder bed.

### BACKGROUND

In additive manufacturing, such as selective laser sintering or selective laser melting, a pulverulent material, for example a metal or ceramic powder, is subjected to electromagnetic radiation. Thin powder bed layers are applied one after the other in a chamber on a building platform in order to form three-dimensional objects by subjecting the respective powder bed layers to an irradiation beam, for example a laser beam. Corresponding devices are referred to as additive manufacturing devices, 3D printing systems, selective laser sintering machines or selective laser melting machines and the like. Reference is made, for example, to EP 2 732 890 A2 regarding the mode of operation of such a device.

In recent years, the additive manufacture of components has also become increasingly important in the industrial environment. Additive manufacturing in a powder bed (e.g., powder bed fusion (PBF)), in which thin powder bed layers, for example of metal, ceramic or thermoplastic powder, are applied in stages and solidified locally using one or more beams to successively build up the component, is particularly suitable for manufacturing complex and filigree components. Machines that are suitable for carrying out a PBF method are referred to below as PBF machines. In this context, lasers and electron beam systems are usually used as beam sources. When a laser source is used, this is also referred to as laser powder bed fusion (LPBF). The beam can sinter or melt the powder to solidify it, creating a material bond with previously solidified component layers in the process. Depending on the beam source, sintering is referred to as selective laser sintering (SLS) or electron beam sintering, while melting is referred to as selective laser melting (SLM) or electron beam melting (EBM). Powder bed-based additive manufacturing of metal powder using a laser beam is also known as laser metal fusion (LMF), for example.

Systems in which a powder bed layer is divided into multiple rigid segments are known from the prior art. These segments are processed by the laser beams one after the other in order to prevent a single laser beam from running ahead. One of the disadvantages of this is that very short vectors can occur in edge regions where individual islands of a component exist in multiple neighboring segments, which can lead to local overheating. This is the case, for example, when an island protrudes just beyond a neighboring segment. Furthermore, segmentation creates many seams between neighboring segments, which can lead to uncontrolled cooling in the component, among other things.

### SUMMARY

In an embodiment, the present disclosure provides a method for an additive manufacture of at least one component in layers in a powder bed using at least two beams which can be deflected two-dimensionally. The method includes: dividing the powder bed including multiple powder bed layers into multiple segments by means of multiple segmentation lines running approximately perpendicularly to a direction of a gas flow, wherein the gas flows in a substantially parallel manner over the powder bed; solidifying, using the at least two beams, the at least one component to be solidified by means of a substantially equal laser load within a segment of a powder bed layer of the multiple powder bed layers; and adapting individual segmentation lines of each powder bed layer based on a criterion.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically shows a PBF machine for the powder bed-based additive manufacture of components according to an embodiment of the present disclosure;

FIG. 2a schematically shows a powder bed layer with islands of at least one component to be solidified according to the prior art;

FIG. 2b schematically shows a powder bed layer with islands of at least one component to be solidified according to an embodiment of the present disclosure;

FIG. 3a schematically shows a powder bed layer with islands of at least one component to be solidified according to the prior art;

FIG. 3b schematically shows a powder bed layer with islands of at least one component to be solidified according to an embodiment of the present disclosure;

FIG. 4 schematically shows a planning device for creating a control program for controlling a PBF machine; and

FIG. 5 schematically shows a planning device distributed over two computers.

### DETAILED DESCRIPTION

In some examples, embodiments of the present disclosure relate to a method, and in particular embodiments an LMF, SLS or EBM method, for an additive manufacture of at least one component in layers in a powder bed using at least two beams which can be deflected two-dimensionally, a control program which has code means adapted to carry out all the steps of the method, and a planning device for creating a control program for controlling a machine for an additive manufacture of at least one component in layers in a powder bed using at least two beams which can be deflected two-dimensionally over a common powder bed region.

An embodiment of the present disclosure provides a method that can be easily automated, can also be implemented in a simple manner in existing additive manufacturing devices and can preferably be carried out during the entire manufacturing process.

Embodiments of the present disclosure can improve or overcome one or more aspects of the prior art systems, and in particular embodiments, can avoid localized overheating.

Some embodiment of the present disclosure provide a method, and in particular embodiments an LMF, SLS or EBM method, for an additive manufacture of at least one component in layers in a powder bed using at least two beams which can be deflected two-dimensionally, a control program which has code means adapted to carry out all the steps of the method, and a planning device for creating a control program for controlling a machine for an additive manufacture of at least one component in layers in a powder bed using at least two beams which can be deflected two-dimensionally over a common powder bed region.

According to a first aspect, the present disclosure discloses a method, and in particular embodiments an LMF, SLS or EBM method, for an additive manufacture of at least one component in layers in a powder bed using at least two beams which can be deflected two-dimensionally, wherein the powder bed has multiple powder bed layers which are divided into multiple segments by means of multiple segmentation lines running approximately perpendicularly to the direction of a gas flow, wherein the gas flows in a substantially parallel manner over the powder bed, wherein the at least two beams solidify the at least one component to be solidified by means of a substantially equal laser load within a segment of the powder bed layer, and wherein individual segmentation lines of each powder bed layer are adapted or displaced on the basis of a criterion. In a preferred embodiment, the gas flow is parallel to the plane spanned by the powder bed. The adaptation of the segmentation lines is preferably understood as a displacement of the segmentation line. In a particular embodiment, this means that the segmentation line is displaced in parallel.

According to a second aspect, the present disclosure discloses a method, and in particular embodiment an LMF, SLS or EBM method, for an additive manufacture of at least one component in layers in a powder bed using at least two beams which can be deflected two-dimensionally, wherein the powder bed has multiple powder bed layers which are divided into multiple segments by means of multiple variable segmentation lines running approximately perpendicularly to the direction of a gas flow, wherein the gas flows in a substantially parallel manner over the powder bed, wherein the at least two beams solidify the at least one component to be solidified by means of a substantially equal laser load within a segment of the powder bed layer, and wherein the variable segmentation lines of each powder bed layer are set on the basis of a criterion.

Advantageously, the first and second aspects of the present disclosure overcome the above-mentioned disadvantages of the prior art. In a particular embodiment, a method is provided that can be easily automated, can also be implemented in a simple manner in existing additive manufacturing devices and can preferably be carried out during the entire manufacturing process. Furthermore, localized overheating in the component can be avoided.

An island refers to a single, contiguous area of the cross-section of a component to be solidified or that has been solidified in a powder bed layer. A contour run is understood to refer to a solidification along a section of the target outline or along the entire target outline of an island. In this regard, the contour run can be formed by a single or multiple overlapping solidification steps, wherein the outline of the island is formed by the outer edge of the contour run. Such contour runs are known, for example, from DE 10 2005 027 0311 B3. Contour runs allow for increased surface quality, such as through homogeneous material properties or a reduction in surface roughness. Such contour runs can be approximated, for example, by contiguous linear vectors along which the beam is deflected over the powder bed. When solidifying the island, a distinction is made at least between the contour run and the other, inner regions. These inner regions can be solidified according to various scanning strategies, for example divided into strips or checkerboard fields. With the strip strategy, the inner region of the island is solidified strip by strip, wherein the beam solidifies each strip by deflecting along vectors aligned substantially perpendicular to the strip. Such a strategy is described in detail in EP 2956262 A2, for example. With the checkerboard strategy, the inner region of the island is usually divided into square sections, which are solidified along vectors arranged parallel to a pair of side faces of each square section. For adjacent square sections, the vectors are, in this regard, usually rotated by 90° to one another. Such a strategy has been disclosed, for example, in CN 105750543 A. The surface roughness is reduced by means of the contour runs, as the contour of the island no longer comprises numerous vector start points and vector end points, along which the regions of an island that are on the inside compared to the contour run are solidified.

In this regard, a vector represents a trajectory of a beam to be executed during the solidification of the powder bed, which is created during the planning of the solidification.

A powder bed layer usually has a layer thickness of 20 μm to 120 μm, preferably 40 μm to 80 μm.

In a further embodiment, the criterion for adapting individual segmentation lines of a respective powder bed layer is selected from: the geometry of at least one island of the at least one component, the slice contour of the at least one island of the at least one component and/or the change in melt volume.

In a preferred embodiment, the segmentation line is displaced to a point at which the slice contour of at least one island of the at least one component changes at least approximately abruptly and/or at which the geometry of at least one island of the at least one component changes at least approximately abruptly and/or at which the volume of at least one island of the at least one component is distributed more evenly among the segments.

Advantageously, the segmentation lines are displaced in such a way that very short vectors in edge regions are avoided. This leads to a more even utilization of the beams. Furthermore, localized overheating can be avoided.

In another variant, the segments of a respective powder bed layer are machined by the at least two beams against the direction of gas flow. The advantage of this is that the residue/dirt and such resulting from the machining process does not contaminate the powder bed layer still to be machined or impair the further machining process.

In a further embodiment, within a segment of the powder bed layer the at least two beams solidify the at least one island of the at least one component to be machined by means of a substantially equal laser load. This prevents one beam from running ahead of the other and ensures a high degree of productivity.

In a preferred embodiment, the segmentation lines are substantially straight and/or curved, at least in sections. In another variant of the method, the segmentation lines are displaced in sections, and in a preferred embodiment, abruptly. This has the advantage that the segmentation lines can be optimally adapted to the circumstances.

In a further embodiment, the segments formed from the segmentation lines have a predefined width, wherein the segments, in a preferred embodiment, have a width of 1 to 15 cm. In a preferred embodiment, the segments formed from the segmentation lines have substantially the same width and/or substantially the same volume.

In another embodiment, the laser load is defined by a combination of the scan speed, the length of the vectors and predetermined delays/minimum times. An alternative simple approximation is the exposure area or the exposure time. The exposure time depends on the scan speeds, the length of the vectors in the exposure area and the defined delays/minimum times.

According to a third aspect, the present disclosure discloses a control program which has code means adapted to carry out all the steps of the method for an additive manufacture of at least one component in layers in a powder bed using at least two beams when the control program is executed on a machine controller of an additive manufacturing device, in a particular embodiment an LMF, SLS or EBM machine.

Advantageously, the third aspect of the present disclosure overcomes the above-mentioned disadvantages of the prior art. In a particular embodiment, a control program is provided that can be easily carried out or executed in an automated manner, can also be implemented in a simple manner in existing additive manufacturing devices and can, in a preferred embodiment, be carried out during the entire manufacturing process. Furthermore, localized overheating in the component can be avoided. In this regard, a typical control program usually has a data volume in the range of megabytes to gigabytes and thus such a large number of instructions for the machine controller that a manual execution is not feasible. The control program, on the other hand, has the advantage that the instructions can be executed in an automated manner. In this context, a control program usually contains information on the layer thickness of the powder bed layers to be applied, the vectors to be solidified and, in particular, machining parameters, for example on the basis of the layer thickness or the powder to be used.

According to a fourth aspect, the present disclosure discloses a planning device for creating a control program for controlling a machine for an additive manufacture of at least one component in layers in a powder bed using at least two beams which can be deflected two-dimensionally over a common powder bed region, the planning device comprising: a vector module for creating vectors for the control program that calculates vectors to at least one island to be solidified in each powder bed layer such that, when a solidification is carried out along the vectors using beams on the machine, the island is formed; an assignment module, which is formed as part of the vector module or as a separate module, which assigns one of the multiple available beams of the machine to every vector of the control program in such a way that the control program is adapted, when executed on a machine controller of the machine, in a particular embodiment, an LMF, SLS or EBM machine, to carry out the method for an additive manufacture of at least one component in layers in a powder bed using at least two beams, and a control interface for controlling the machine according to the control program or for exporting the control program for transmission to a machine controller.

Advantageously, the fourth aspect of the present disclosure overcomes the above-mentioned disadvantages of the prior art. In a particular embodiment, a planning device is provided that can be easily automated, can also be implemented in a simple manner in existing additive manufacturing devices and can, in a preferred embodiment, be carried out during the entire manufacturing process. Furthermore, localized overheating in the component can be avoided. In addition to the advantages of the method, this also allows for the automated creation of a control program, taking into account rules that avoid detrimental interactions between beams. For example, it could be disadvantageous if the beams solidify the powder bed layer in the immediate vicinity, as this could lead to local overheating or the emissions during solidification could adversely affect the respective other beam.

Such a planning device often comprises a computer program that is run on a machine controller or a separate computer. In powder bed-based additive manufacturing, such planning devices are often referred to as build processors. Build processors are known from the prior art, of which there are machine-specific customized versions, such as for LMF and EBM machines from various manufacturers. Such a planning device creates control programs of the type described above from information on a component to be manufactured, in particular in an automated manner. The use of such planning devices is particularly relevant for the manufacture of complex components, as the manual programming of the control programs to be created cannot be achieved within an economically reasonable time and at a required level of quality due to the amount of data in the range of megabytes or gigabytes.

The planning device comprises a vector module for creating vectors for the control program that calculates vectors to at least one island to be solidified in each powder bed layer such that, when a solidification is carried out along the vectors using beams on the machine, the island is formed, wherein the vectors form a contour run for at least one selection of the islands. This makes it possible to create control programs with different scanning strategies in an automated manner, for example with a strip strategy or a checkerboard strategy.

Furthermore, the planning device comprises an assignment module, which is formed as part of the vector module or as a separate module, which assigns one of the multiple available beams of the machine to every vector of the control program in such a way that the control program is adapted, when executed on a machine controller of the machine, and in particular embodiments an LMF, SLS or EBM machine, to carry out the aforementioned method. In addition to the advantages of the method, this also allows for the automated creation of a control program, taking into account rules that avoid detrimental interactions between beams. For example, it could be disadvantageous if the beams solidify the powder bed layer in the immediate vicinity, as this could lead to local overheating or the emissions during solidification could adversely affect the respective other beam.

In addition, the planning device comprises a control interface for controlling the machine according to the control program or for exporting the control program for transmission to a machine controller. If the planning device is designed to control the machine, it is usually part of the machine controller so that the large control program does not have to be transmitted via the network of the machine operator, for example. A planning device that exports the control program for transmission, on the other hand, has the advantage that the control program can be transferred to any, optionally multiple, suitable machines. The planning device can, for example, comprise a computer independent of the machine or be executed on it.

According to a further embodiment, the planning device further comprises: an input interface for importing powder bed layer data of a component to be additively manufactured in layers, and/or a slicing module for creating the powder bed layer data of the component from a blueprint of the component, wherein the powder bed layer data comprises information about the islands of multiple powder bed layers, in a particular embodiment all powder bed layers, that are to be solidified. This has the advantage that the blueprint of the component to be manufactured, i.e., the design created with a design module, can be created on another, independent computer or with another, independent computer program. According to the prior art, a design module is usually referred to as a program for computer-aided design (CAD) or computer-assisted design. The advantage of this variant is that design modules from any manufacturer can be used. It can also be advantageous if no design has to be created at the machine, as the operating possibilities may be limited compared to an office workstation, for example due to a smaller screen or less ergonomic operating devices.

In a preferred embodiment, the planning device comprises a machine controller and/or at least one further computer. This means that some functions can be carried out at an ergonomic office workstation, for example on a laptop or desktop workstation, while others can be carried out on the machine, thus avoiding the time-consuming transfer of large amounts of data, such as control programs, between the office workstation and the machine.

In a further embodiment of the planning device, each of the modules is implemented on one or more of the computers. This means that the above-mentioned advantages of the ergonomic office workstation and the avoidance of lengthy data transfers can be utilized in a flexible manner.

Other features and aspects of this disclosure will become apparent from the following description and the accompanying drawings.

The accompanying drawings, which are incorporated herein and form a part of the description, illustrate exemplary embodiments of the disclosure and, together with the description, serve to explain the principles of the disclosure.

The following is a detailed description of exemplary embodiments of the present disclosure. The exemplary embodiments described herein and illustrated in the drawings are intended to teach the principles of the present disclosure and to enable the average person skilled in the art to implement and use the present disclosure in many different environments and for many different applications. Therefore, the exemplary embodiments are not intended to be, and should not be construed as, limiting the scope of protection. Rather, the scope of protection is to be defined by the appended claims.

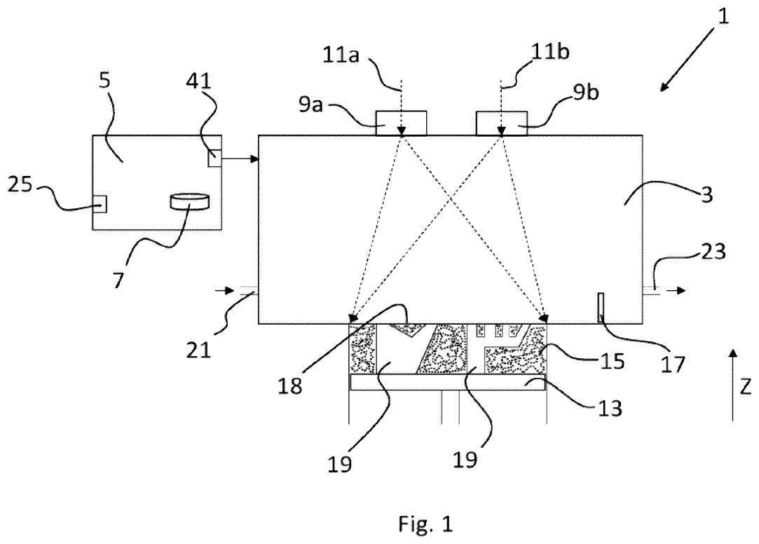

FIG. 1 schematically shows a PBF machine 1 with a process chamber 3 and a machine controller 5. The machine controller 5 has a data carrier 7 for storing control programs. The PBF machine 1 also has at least two scanners 9a, 9b, each of which deflects a beam 11a, 11b. The scanner 9a, 9b can, for example, comprise a scanner mirror that can be rotated in two directions or two scanner mirrors that can be rotated in one direction for a laser beam. The scanner 9a, 9b can, for example, comprise a galvanometer scanner. Alternatively, the scanner 9a, 9b can comprise multiple pairs of electrodes for an electron beam, between which an electric field can be applied in order to deflect the electron beam.

The PBF machine 1 further comprises a substrate plate 13, which is arranged below the scanners 9a, 9b and on which a powder bed 15 is applied in layers. For this purpose, the substrate plate 13 is adjusted by a desired distance in the −Z direction, i.e., in the direction of increasing distance from the scanners 9a, 9b, and a new powder bed layer is then applied using a powder slider 17. Powder sliders 17 can be wipers, blades or cylinders, for example. In this case, the scanners 9a, 9b are suitable for deflecting their respective beams 11a, 11b over the entire powder bed 15. Thus, in this exemplary embodiment, the entire powder bed surface constitutes a common powder bed region 18 in which the beams 11a, 11b can solidify the powder. After solidifying the uppermost powder bed layer in each case, the substrate plate 13 can be adjusted again in the −Z direction and a new powder bed layer can be applied in order to produce components 19 in layers. The layer of the at least one component 19 to be solidified in a powder bed layer is referred to as an island 20; 20a, 20b. An island 20; 20a, 20b is thus a “disc” of the at least one component 19, wherein multiple islands 20; 20a, 20b can be present in one layer, which are only associated with one component 19.

The process chamber 3 is designed to be gas-tight and comprises a gas inlet 21 and a gas outlet 23. The gas inlet 21 can be used to fill the process chamber 3 with an inert gas such as nitrogen or argon to prevent oxidation of the powder. Together with the gas outlet 23, a continuous flow of shielding gas can also be formed above the powder bed 15 in order to remove condensates, powder particles and other particles ejected into the atmosphere by the process during solidification using laser beams, in order to reduce possible interference with the laser beam. The gas outlet 23 can also be used to evacuate the process chamber 3 such that electron beams can be used as the beams 11a, 11b. For this purpose, the process chamber 3 can be designed to be vacuum-tight.

The machine controller 5 also has a data interface 25 via which, for example, control programs can be imported. When executing a control program via a control interface 41, the machine controller 5 can carry out all of the steps required for the additive manufacture in layers on the machine, such as activating or deactivating the beams 11a, 11b, deflecting them with the scanner 9a, 9b, adjusting the substrate plate 13 along the Z-axis or initiating a powder application.

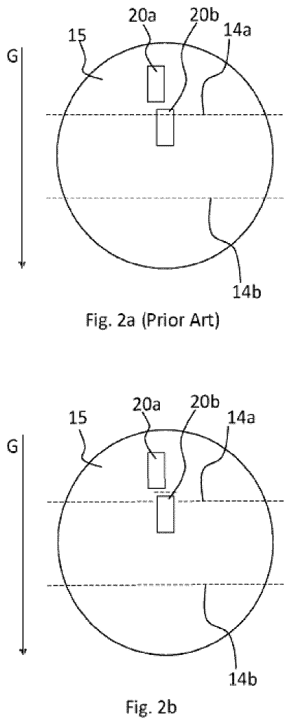

FIG. 2a schematically shows a powder bed layer with two islands 20a, 20b of the at least one component 19 to be solidified according to the prior art. Here, the powder bed layer is divided into three segments with the help of segmentation lines 14a, 14b. The segmentation lines 14a, 14b are arranged at the same distance from one another and are rigid, i.e., equally spaced from one another in each layer. It is irrelevant in this regard at which positions the islands 20a, 20b to be solidified are positioned on the powder bed layer.

FIG. 2b schematically shows a powder bed layer with two islands 20a, 20b of the at least one component 19 to be solidified according to an embodiment of the present disclosure.

Here, the powder bed layer is divided into three segments with the help of segmentation lines 14a, 14b. In this regard, the segmentation lines 14a, 14b are arranged for the most part at the same distance from one another, wherein the segmentation line 14a has been raised in sections such that the island 20b lies within a segment. As a result, the island 20b, which is now located within a single segment, can be machined evenly without a segment change or transition from one segment to another.

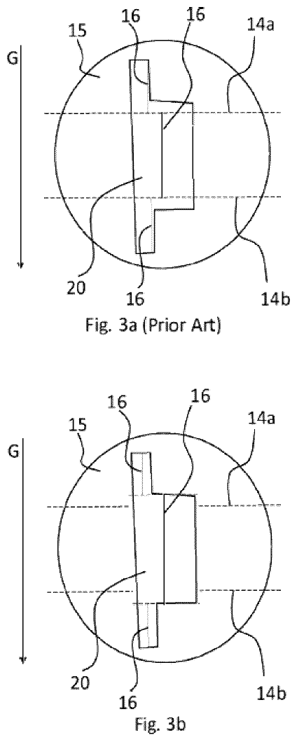

FIG. 3a schematically shows a powder bed layer with an island 20 of the at least one component 19 to be solidified according to the prior art. Here, the powder bed layer is divided into three segments with the help of segmentation lines 14a, 14b. The segmentation lines 14a, 14b are arranged at the same distance from one another and are rigid, i.e., equally spaced from one another in each layer. It is irrelevant in this regard at which positions the island 20 to be solidified is positioned on the powder bed layer.

FIG. 3b schematically shows a powder bed layer with an island 20 of the at least one component 19 to be solidified according to an embodiment of the present disclosure.

Here, the powder bed layer is divided into three segments with the help of segmentation lines 14a, 14b. In this regard, the segmentation lines 14a, 14b are arranged for the most part at the same distance from one another, wherein the segmentation lines 14a, 14b have been displaced in sections at points at which the geometry of the island 20 of the at least one component 19 changes at least approximately abruptly and/or at which the volume of the island 20 of the at least one component 19 is divided more evenly among the segments.

As can be seen by looking at FIGS. 3a and 3b together, the assignment lines 16 in FIG. 3b are arranged substantially more centrally in the segment sections of the island 20. The assignment line 16 is a virtual line which divides the machining region of the beams 11a, 11b into sections with equal laser load. Here, the left section is solidified by the beam 11a, wherein the right, opposite section is solidified by the beam 11b. Advantageously, this can avoid very short vectors in edge regions, as is the case in FIG. 3a. These can lead to localized overheating in the component 19.

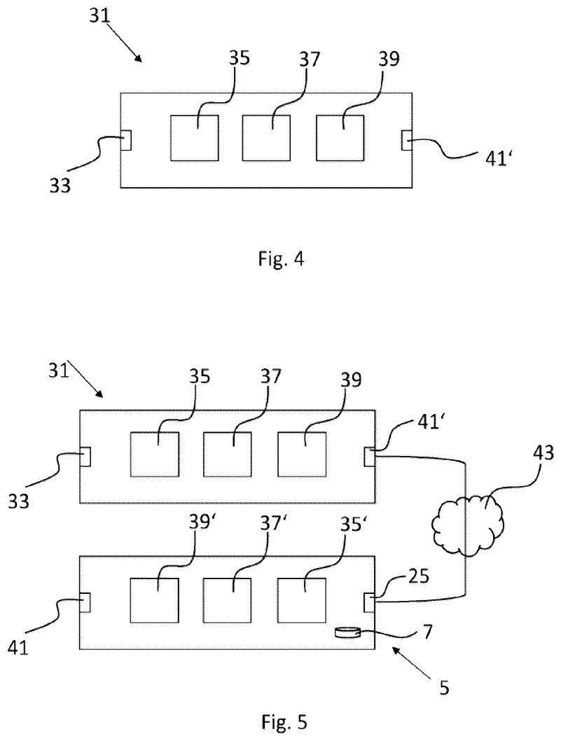

FIG. 4 schematically shows a planning device 31 for creating a control program for controlling a PBF machine 1 for powder bed-based additive manufacturing using at least two beams 11a, 11b, which can be deflected two-dimensionally over a common powder bed region 18. The planning device 31 comprises an input interface 33, a slicing module 35, a vector module 37, an assignment module 39 and a control interface 41′.

The input interface 33 is used to import powder bed layer data of a component 19 to be additively manufactured in layers from a blueprint of the component 19.

The slicing module 35 creates the powder bed layer data of the component 19 from a blueprint of the component 19, wherein the powder bed layer data comprises information about the islands of multiple powder bed layers, in particular all powder bed layers, that are to be solidified.

The vector module 37 creates vectors for the control program. Here, the vector module 37 calculates vectors to at least one island to be solidified in each powder bed layer such that, when a solidification is carried out along the vectors using beams 11a, 11b on the machine 1, the island is formed, wherein the vectors form a contour run for at least one selection of the islands.

The assignment module 39 is designed as part of the vector module 37 or as a separate module. Here, the assignment module 39 assigns one of the multiple available beams 11a, 11b of the machine 1 to every vector of the control program in such a way that the control program is adapted, when executed on a machine controller of the machine 1, in particular an LMF, SLS or EBM machine, to carry out the method for an additive manufacture of at least one component 19 in layers in a powder bed 15 using at least two beams 11a, 11b, which can be deflected two-dimensionally over a common powder bed region 18.

The control interface 41′ controls the machine 1 according to the control program or exports the control program in order to transmit it to a machine controller.

FIG. 5 schematically shows one way of transmitting the data from the planning device 31 to the machine controller 5, which optionally has an internal data carrier 7. The data from the planning device 31 is transmitted via a data interface 25 of the machine controller 5. This transmission can be carried out, for example, using a data carrier such as a USB stick or a network 43 (intranet, Internet).

It is expressly noted that all features disclosed in the description and/or claims are intended to be disclosed separately and independently of one another for the purpose of the original disclosure as well as for the purpose of limiting the claimed invention, irrespective of the composition of features in the embodiments and/or claims. It is expressly noted that all ranges of values or indications of groups of units disclose every possible intermediate value for the purpose of the original disclosure as well as for the purpose of limiting the claimed invention, in particular as boundaries of ranges of values.

Although the preferred embodiments of the present disclosure have been described herein, improvements and modifications may be included without departing from the scope of the following claims.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SYMBOLS

1 PBF machine
3 Process chamber
5 Machine controller
7 Data carrier
9a, 9b Scanner
11a, 11b Beam
13 Substrate plate
14a, 14b Segmentation line
15 Powder bed
16 Assignment line
17 Powder slider (wiper, blade, cylinder)
18 Common powder bed region
19 Component
20; 20a, 20b Island
21 Gas inlet
23 Gas outlet
25 Data interface
31 Planning device
33 Input interface
35 Slicing module
37 Vector module
39 Assignment module
41, 41′ Control interface
43 Network (intranet, Internet)
G Gas flow direction/direction of gas flow
Z Z direction

What we claim is:

1. A method for an additive manufacture of at least one component in layers in a powder bed using at least two beams which can be deflected two-dimensionally, the method comprising:
dividing the powder bed comprising multiple powder bed layers into multiple segments by means of multiple segmentation lines running approximately perpendicularly to a direction of a gas flow, wherein the gas flows in a substantially parallel manner over the powder bed;
solidifying, using the at least two beams, the at least one component to be solidified by means of a substantially equal laser load within a segment of a powder bed layer of the multiple powder bed layers; and
adapting individual segmentation lines of each powder bed layer based on a criterion.

2. A method for an additive manufacture of at least one component in layers in a powder bed using at least two beams which can be deflected two-dimensionally, the method comprising:
dividing the powder bed comprising multiple powder bed layers into multiple segments by means of multiple variable segmentation lines running approximately perpendicularly to a direction of a gas flow, wherein the gas flows in a substantially parallel manner over the powder bed;
solidifying, using the at least two beams, the at least one component to be solidified by means of a substantially equal laser load within a segment of a powder bed layer of the multiple powder bed layers; and
setting the multiple variable segmentation lines of a respective powder bed layer based on a criterion.

3. The method according to claim 1, wherein the criterion for adapting the individual segmentation lines of the respective powder bed layer is selected from: a geometry of at least one island of the at least one component, a slice contour of the at least one island of the at least one component and/or a change in melt volume.

4. The method according to claim 1, wherein the individual segmentation lines are displaced to or set at a point at which a slice contour of at least one island of the at least one component changes at least approximately abruptly and/or at which a geometry of at least one island of the at least one component changes at least approximately abruptly and/or at which a volume of at least one island of the at least one component is distributed more evenly among the multiple segments.

5. The method according to claim 1, wherein the multiple segments of the respective powder bed layer are machined by the at least two beams against the direction of gas flow.

6. The method according to claim 1, wherein within a segment of the powder bed layer the at least two beams solidify at least one island of the at least one component to be machined by means of a substantially equal laser load.

7. The method according to claim 1, wherein the multiple segmentation lines are substantially straight and/or curved, at least in sections.

8. The method according to claim 1, wherein the multiple segmentation lines are displaced in sections abruptly.

9. The method according to claim 1, wherein the segments formed from the segmentation lines have a predefined width, wherein the segments preferably have a width of 1 to 15 cm.

10. The method according to claim 1, wherein the multiple segments formed from the multiple segmentation lines have substantially a same width and/or substantially a same volume.

11. The method according to claim 6, wherein the laser load is defined by a combination of a scan speed, a length of the vectors and predetermined delays.

12. A non-transitory computer readable medium which, when executed by one or more processors, is adapted to carry out all the steps of the method according to claim 1 when the control program is executed on a machine controller of an additive manufacturing device.

13. A planning device for creating a control program for controlling a machine for an additive manufacture of at least one component in layers in a powder bed using at least two beams which can be deflected two-dimensionally over a common powder bed region, the planning device comprising:
a vector module for creating vectors for the control program that calculates the vectors to at least one island to be solidified in each powder bed layer such that, when a solidification is carried out along the vectors using the at least wo beams on the machine, the at least one island is formed,
an assignment module, which is formed as part of the vector module or as a separate module, which assigns one of the at least two beams that are available of the machine to every vector of the control program in such a way that the control program is adapted, when executed on a machine controller of the machine to carry out the method according to claim 1, and
a control interface for controlling the machine according to the control program or for exporting the control program for transmission to the machine controller.

14. The planning device according to claim 13, wherein the planning device further comprises: an input interface for importing powder bed layer data of the at least one component to be additively manufactured in layers, and/or a slicing module for creating the powder bed layer data of the at least one component from a blueprint of the at least one component, wherein the powder bed layer data comprises information about the islands of the at least one island of multiple powder bed layers that are to be solidified.

15. The planning device according to claim 13, wherein the planning device comprises a machine controller and/or at least one further computer.

16. The method according to claim 1, wherein the method is a laser metal fusion (LMF), selective laser sintering (SLS), or electron beam melting (EBM) method.

17. The method according to claim 2, wherein the method is a laser metal fusion (LMF), selective laser sintering (SLS), or electron beam melting (EBM) method.

18. The method according to claim 2, wherein the criterion for setting the variable segmentation lines of the respective powder bed layer is selected from: a geometry of at least one island of the at least one component, a slice contour of the at least one island of the at least one component and/or a change in melt volume.

19. The method according to claim 12, wherein the additive manufacturing device is a laser metal fusion (LMF), selective laser sintering (SLS), or electron beam melting (EBM) device.

20. The planning device according to claim 13, wherein the machine is a laser metal fusion (LMF), selective laser sintering (SLS), or electron beam melting (EBM) machine.
